(19) United States
(12) Patent Application Publication
(10) Pub. No.: US 2013/0021878 A1
(43) Pub. Date: Jan. 24, 2013

(54) Container for Pills or Vitamins and Methods of Use

(71) Applicant: Michelle Louise Harris, San Francisco, CA (US)

(72) Inventor: Michelle Louise Harris, San Francisco, CA (US)

(21) Appl. No.: 13/484,205

(22) Filed: May 30, 2012

Related U.S. Application Data
(60) Provisional application No. 61/510,410, filed on Jul. 21, 2011.

(51) Int. Cl. G04B 47/00

(52) U.S. Cl. 368/10

(57) ABSTRACT

Containers for pills and/or vitamins, and methods of use. According to some embodiments, an exemplary container may include a body having a cavity for receiving a pill, the body having an opening for dispensing the pill, a timer, and a lid operatively connected to the body, the lid being selectively movable between a closed position to retain the pill within the body and an open position for dispensing the pill from the body, wherein selectively moving the lid from the closed position to the open position activates a timer.

### CROSS-REFERENCE TO RELATED APPLICATION

This non-provisional US patent application claims the priority benefit of U.S. provisional application No. 61/510,410, filed on Jul. 21, 2011 and titled “CONTAINER FOR PILLS OR VITAMINS AND METHODS OF USE,” which is hereby incorporated by reference herein in its entirety.

### FIELD OF THE PRESENT TECHNOLOGY

The present technology relates generally to containers for pills and vitamins, and more specifically, but not by way of limitation, to containers for pills and vitamins that are discrete and incorporate features such as timers.

### BACKGROUND

Containers for pills and/or vitamins are often bulky and are often labeled with private medical information such as a drug and patient names. Additionally, conventional containers are often transparent. Dispensing pills or other products from these conventional containers is often a frustrating user experience where multiple pills may be dispensed when only one pill is desired. Thus, dispensing pills from conventional containers may result in loss, damage, and/or contamination of pills. Additionally, conventional containers have no means for tracking pill consumption information, such as time etc.

### SUMMARY OF THE PRESENT TECHNOLOGY

According to some embodiments, the present technology may be directed to containers that comprise: (a) a body comprising a cavity for receiving a pill, the body having an opening for dispensing the pill; (b) a timer; and (c) a lid operatively connected to the body, the lid being selectively movable between a closed position to retain the pill within the body and an open position for dispensing the pill from the body, wherein selectively moving the lid from the closed position to the open position activates a timer.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

FIG. 1 is a front perspective view of the exemplary container in an open configuration, constructed in accordance with the present technology.

FIG. 2 is a side elevation view of the exemplary container of FIG. 1.

FIG. 3 is a cross-sectional view of the exemplary container taken along line A-A of FIG. 2.

FIG. 4 is a cross-sectional view of the exemplary container taken along line B-B of FIG. 1.

FIG. 5 is a top down view of the exemplary container of FIGS. 1-4.

FIG. 6 is a front perspective view of an exemplary container of FIG. 1-5 in a closed configuration.

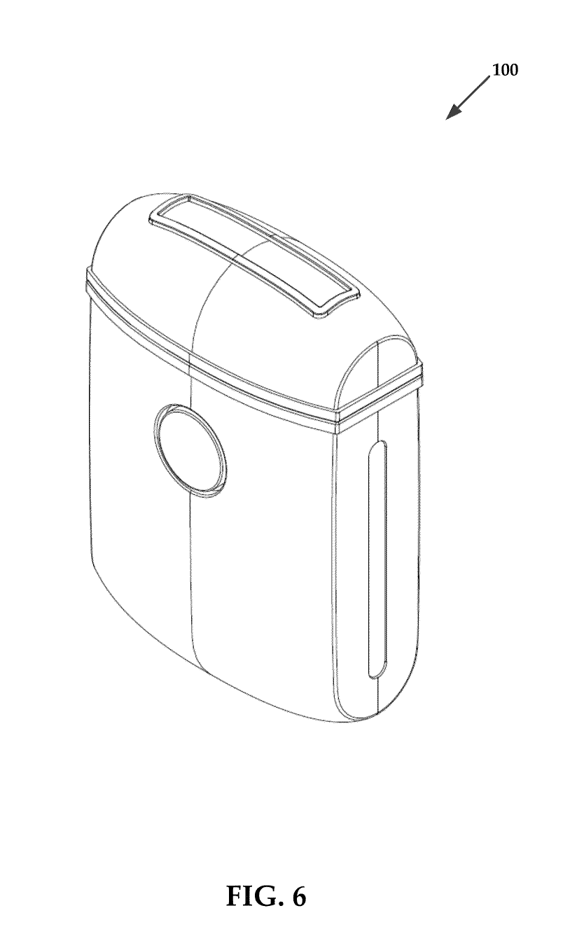

FIG. 7 is a front elevation view of the exemplary container of FIGS. 1-6.

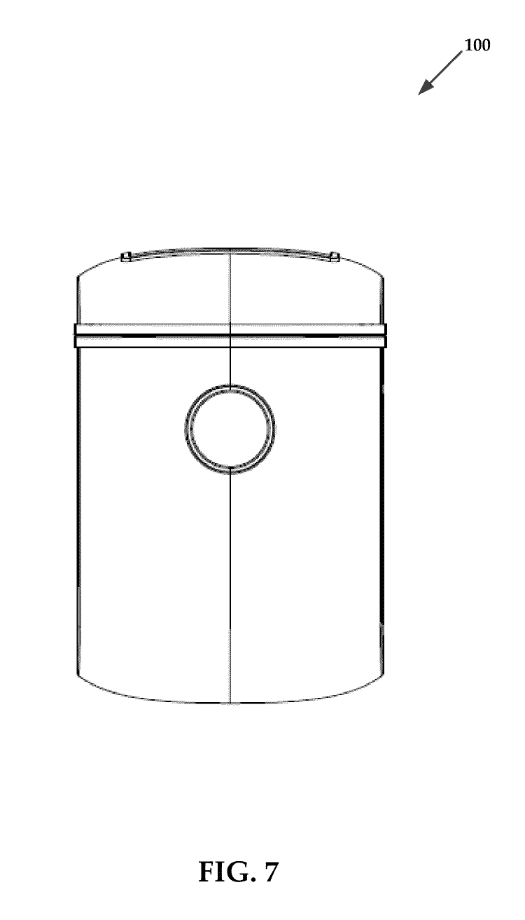

FIG. 8 is a rear elevation view of the exemplary container of FIGS. 1-7.

FIG. 9 is a rear perspective view of the exemplary container of FIGS. 1-8 in a closed configuration.

FIG. 10 is a schematic diagram of an exemplary timer assembly for use in accordance with the present technology.

### DETAILED DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Embodiments according to the present technology include a fashionable, discreet, portable pill container which records and/or marks the time a person dispensed and presumably took his pill and/or vitamin. For the purposes of this disclosure, the term “pill” is understood to mean “pills, tablets, vitamins, or the like”. In some embodiments, the device may be small enough to fit into one's palm, and thus portable enough to place in one's pocket, purse, etc. Some of the optional salient features of some embodiments include but are not limited to: lodging the time one takes one's pill; lighting up to allow sight in the dark; size and weight portable; discreet without having the names of the user and/or pills on the device; waterproof or water-resistant; childproof. A lid being closed (or being open) may activate a timer in various embodiments.

The manner and process of making the device may comprise, in exemplary embodiments, a top which is made of a black metal and that may contain a digital clock (or other type of time-keeping device) that may record the time the top was opened. The clock may be nestled down into the top so as to be both discreet and protected.

Operatively coupled with the top may be a container (possibly colored) which, in some embodiments, can hold up to six large pills, several small pills, or any combination in between. It is envisioned that the container may hold more or fewer pills. It is contemplated that the container may have varying patterns of different colors, or be of one solid color. It is also contemplated that the container may hold any number of pills of varying sizes. The container may be the same width and depth as the top in some embodiments. In is noteworthy that the container may vary in length to permit a user to purchase a container which fits his or her pills.

On one side of the container (e.g., the right side) may be an actuation device (e.g., a recessed button) that opens the smart head (e.g., the lid) and thereby permit dispensing of the pills. A variety of child safety features may also be added. The button may be on either side of the device so that left- and right-handed users may use the device with ease. The button may also be located proximate the midline of the container. In some embodiments, whether on the right or left side, the actuation may be easy enough to push to accommodate persons with dexterity issues.

The container may also include an oval-shaped a window so the user can see how many pills are inside without having to open the top, thereby logging the time.

In some embodiments, the manner and process of using the device may be that in one hand the user depresses the button and the button flips open the top. From the top, the pills may come out (i.e., be dispensed) at an amount to be determined by the user. The pills may placed into the person's other hand, the hand not using depressing the button. Once the desired amount of pills are released from the container, the user may depress the button again to close the top. When the top closes the timer and/or clock may begin.

Thereafter, the user can look at the top of the device and see how many hours and minutes (and possibly seconds) since the container was opened and thereby know how long ago he or she consumed her pill(s). In some embodiments, the device will not contain a person's name, the name of his or medicine, or its dosage, so as to ensure privacy. It some embodiments the contrary may be true.

The device may be small enough to be placed into one's purse or pocket so as to portable. As mentioned, the device may be fashionable too and be offered in a variety of colors so that it can be displayed prominently on one's desk, table, shelving, or the like. The device may include a slide which can pull out for easy loading and cleaning with an optionally included brush or other cleaning device.

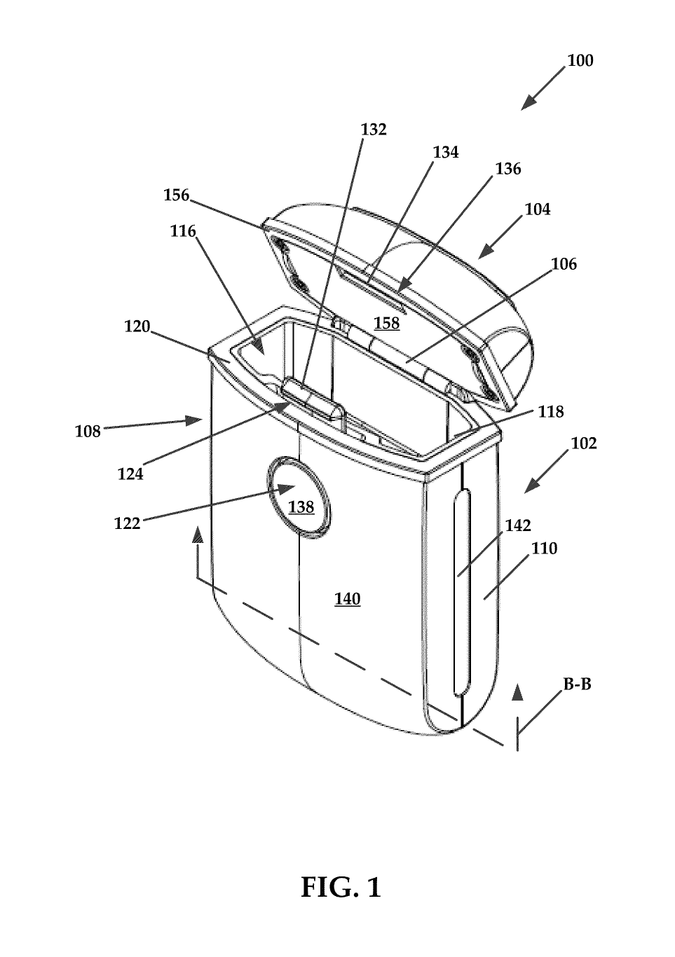

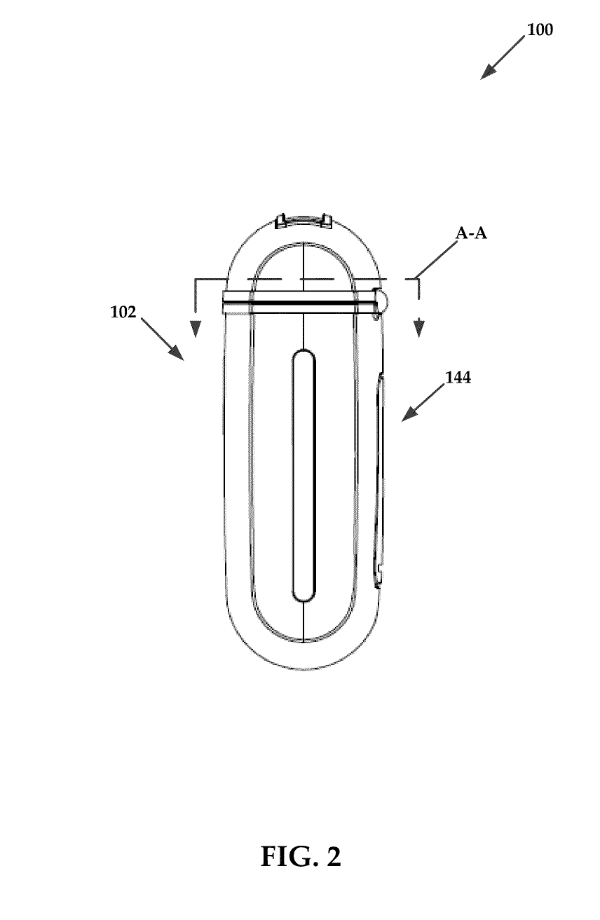

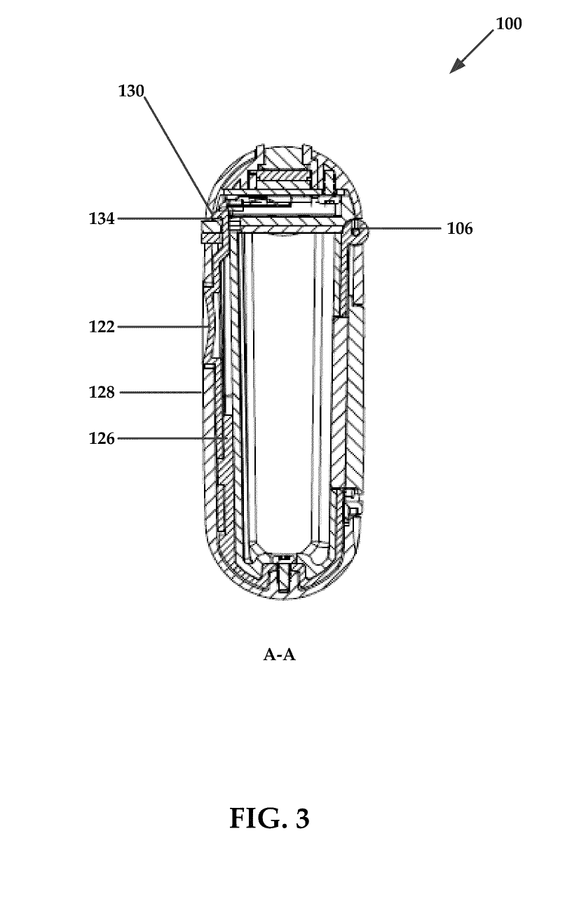

Referring now to the drawings and more particularly to FIGS. 1-3 collectively, which illustrate views of an exemplary container 100. The container 100 is shown as generally comprising a body 102 and a lid 104 that may be pivotally connected to the body 102 via a hinge 106. The hinge 106 may be a passive or active hinge. For example, the hinge 106 may be spring biased to the open (or closed) position, such as shown in FIG. 1.

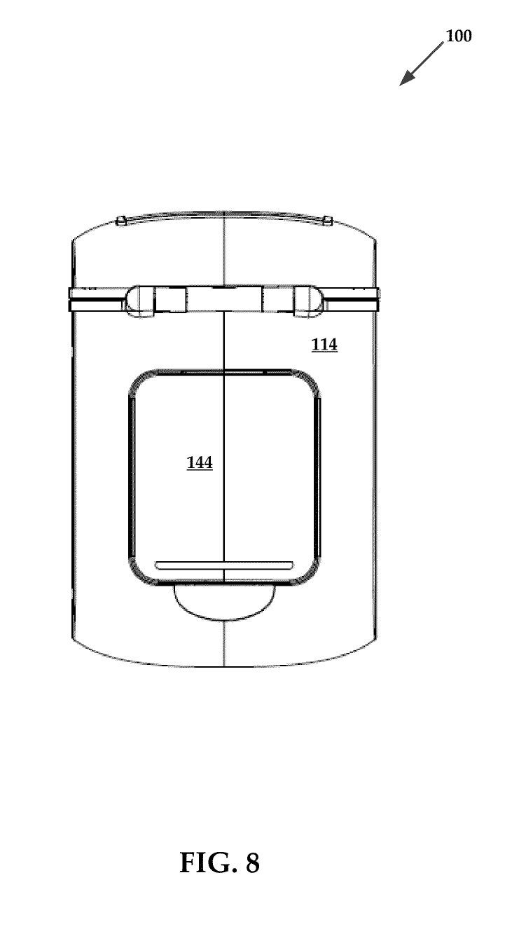

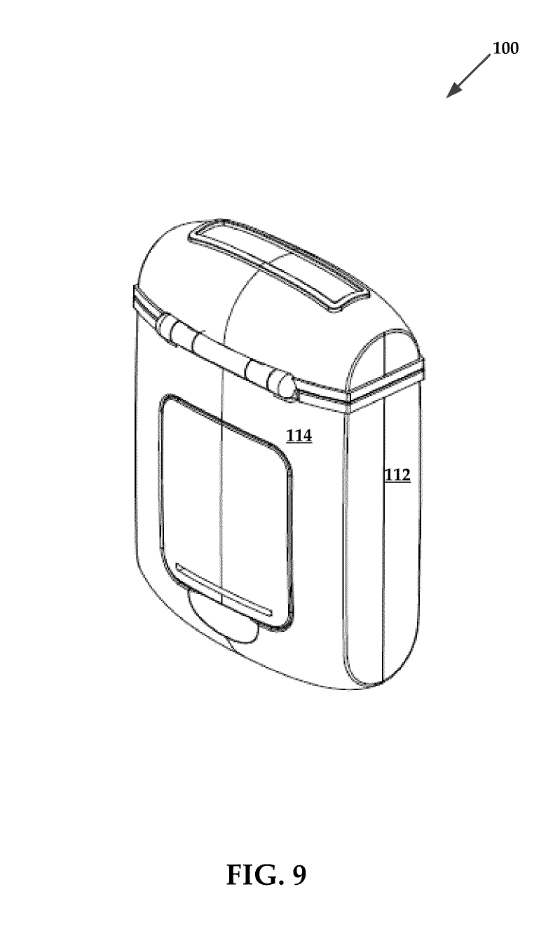

According to some embodiments, the body 102 may be constructed from various component parts such as a front panel 108, two opposing side panels 110 and 112 (see FIG. 9), and a back panel 114 (see FIGS. 8 and 9), that are joined together to form a cavity 116. The components of the body 102 may fabricated from any one (or combination) of a number of materials such as a plastic, a polymer, a resin, a metal, a metal alloy, a natural material such as wood and/rubber, a composite material, or other suitable material that would be known to one or ordinary skill in the art with the present disclosure before them.

In accordance with the present disclosure, the cavity 116 may comprise a sound damping material 118 that lines at least a portion of an inner sidewall of the body 102. The sound damping material 118 may be utilized to prevent pills that are housed within the cavity 116 from contacting the inner surface of the cavity 116. Advantageously, the sound damping material 118 may prevent damage to the pills and may also increase personal privacy by reducing the familiar sound of pills rattling inside a container.

In some embodiments, the body 102 may comprise a first mating flange 120 that correspondingly mates with a second mating flange disposed on the lid 104, as will be described in greater detail below.

The body 102 may also include an actuator 122, which in some instances comprises a substantially round button. The actuator 122 cooperates with a locking member 124 to secure the lid 104 to the body 102 when the lid 104 is selectively moved into the closed position. According to some embodiments, the actuator 122 and the locking member 124 may be constructed from a resilient material. At least a portion of the actuator 122 may be sandwiched between an inner wall 126 and an outer wall 128 of the body 102.

In accordance with the present disclosure, the locking member 124 may be formed integrally with the actuator 122. The locking member 124 may comprise a hook 130 that in turn comprises a substantially arcuate or rounded portion 132.

When the lid 104 is moved to the closed position, the rounded portion 132 of the hook 130 may contact a front edge 134 of an opening 136 pushing the locking member 124 in a rearward direction. This action allows the hook 130 to extend through the opening 136. Once the hook 130 has passed through the opening 136, an inherent resilient biasing of the locking member 124 pushes the hook 130 forwardly to cover the front edge 134 of the opening 136 and prevent the lid 104 from moving to the open position.

The hook 130 may also move “rearwardly” when the actuator 122 is depressed. That is, the actuator 122 may cause selective movement of the lid 104 from the closed position to the open position when the actuator 122 is engaged. When the actuator 122 is depressed, the locking member 124 is caused to move rearwardly, which also moves the hook 130 rearwardly and in substantial alignment with the opening 136. When the hook 130 and opening 136 are substantially aligned, the spring bias of the hinge 106 may cause the lid 104 to selectively move to the open position. If the hinge 106 is passive, the end user may selectively move the lid 104 to the open position.

According to some embodiments, an outer surface 138 of the actuator 122 may be aligned substantially flush with an outer surface 140 of the body 102 to give the container 100 a sleek appearance.

In additional embodiments, the body 102 of the container 100 may comprise a window 142 that provides a view into the cavity 116. According to some embodiments, the window 142 may be constructed from an at least partially opaque material to prevent detailed viewing of the pills within the container 100. That is, the opacity of the window 142 may in some instances allow for an obscured view of the pills, such that one might be able to visually count or roughly determine the number of pills in the container 100, but not specifically identify a color, name, number, or other identifying information regarding the pills. According to some instances, a window may be disposed on either or both of the side panels 110 and/or 112 of the body 102.

Referring now to FIGS. 1-3 and 8 collectively, the body 102 may also comprise a hatch 144 that provides additional access to the cavity 116. The hatch 144 may be pivotally, hingedly, compressively, and or otherwise releaseably connectable with the back panel 114 of the body 102. The hatch 144 allows for pills to be loaded into the cavity 116 without activating a timer that is triggered when the lid 104 is opened, as will be discussed in greater detail below. Similarly to the actuator 122, an outer surface of the hatch 144 may be substantially flush with an outer surface of the back panel 114 to give the container 100 a sleek appearance.

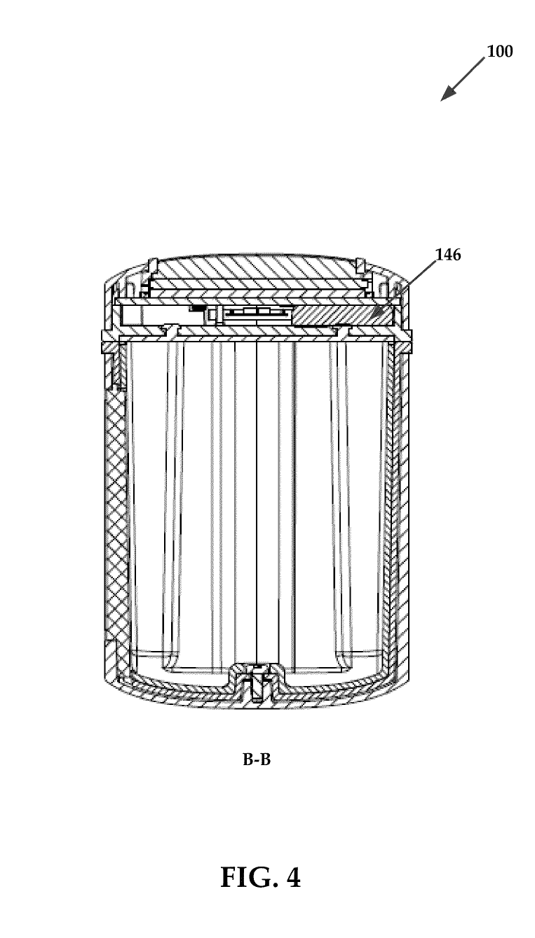

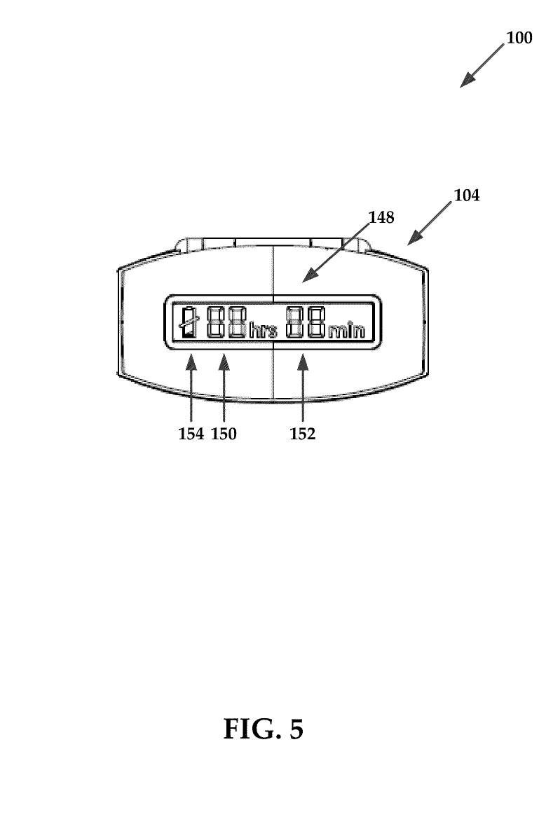

Referring now to FIGS. 4 and 5 collectively, in accordance with the present disclosure, the lid 104 may comprise a timer 146. The timer 146 may provide a general date and time. In other instances, the timer 146 may comprise a count-up or count-down timer. With regard to a count-up timer, when the timer is engaged, the timer 146 may count up from zero. With regard to a count-down timer, when the timer is engaged, the timer 146 may count down from an arbitrary value. This arbitrary value may comprise a period of time. For example, if an individual is scheduled to take a pill every three hours, the timer 146 may be triggered and begin a count down that lasts for a three hour period of time. At the end of the period of time, the timer 146 may cause a sound emitter or other device to provide notification that the period of time has expired. Thus, the individual may be reminded to take another pill by the notification.

Advantageously, triggering of the timer 146 may be tied to the movement of the lid 104 from the closed position to the open position (and vice versa), movement of the hinge 106, and/or depression of the actuator 122.

In some embodiments, the timer 146 may be associated with a display 148 (see FIG. 5) that provides a time reference provided by the timer 146. The display 148 is shown as having an hour component 150 and a minute component 152. The display 148 may also comprise a power icon 154 that displays a currently available power level for a power source. The power source will be described in greater detail below.

The lid 104 may also comprise a second mating flange 156 that is adapted to matingly interface with the first mating flange 120 of the body 102. When the first and second mating flanges are brought in face to face contact with one another, they create a substantially sealed interface between the body 102 and the lid 104.

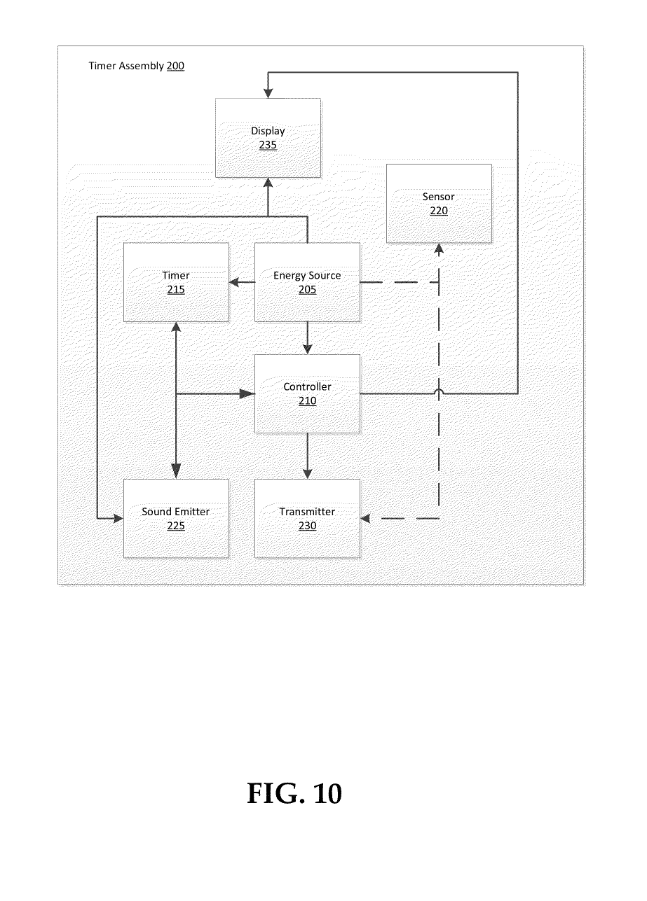

The lid 104 may also comprise a removable panel 158 that allows for access to the inside of the lid 104 to provide access to a timer assembly, such as the timer assembly 200 of FIG. 10, which is described below. Thus, the removable panel 158 may allow for replacement of defective, damaged, and/or used timer assembly components.

The lid 104 may house at least a portion of the timer 146, and in some instances at least a portion of a timer assembly 200.

Referring now to FIG. 10, the timer assembly 200 is shown as generally comprising an energy source 205, a controller 210, a timer 215 (such as the timer of FIG. 4), a sensor 220, a sound emitter 225, a transmitter 230, and a display 235. The energy source 205 may comprise any energy source 205 such as a battery (e.g., primary and/or secondary electrochemical cells), a solar power cell, and so forth. The energy source 205 may provide power to the components of the timer assembly 200.

The controller 210 may be employed to control the data processing, calculating, and other computational processes required by the timer 215, sensor 220, sound emitter 225, and/or transmitter 230. The controller 210 may comprise any suitable microprocessor such as an application specific integrated circuit (“ASIC”) that would be known to one of ordinary skill in the art with the present disclosure before them.

In some instances, the controller 210 may control the operation of the timer 215, such as whether the timer counts upwardly or downwardly. The controller 210 may also monitor threshold values such as a time period. For example, when the timer 215 has counted upwardly from zero to an hour, the controller 210, having a threshold time value set to one hour, will output a timer signal to any of the transmitter 230 or the sound emitter 225.

In other embodiments, the timer 215 may itself output a timer signal to the any of the transmitter 230 or the sound emitter 225.

The sensor 220 may comprise any suitable sensor that can sense when the lid of the container has been opened, closed, and or combinations/sequences of the same. For example, the sensor 220 may comprise any sensor that can determine a pivoting of the hinge that connects the lid to the body of the container. The sensor 220 may also comprise a button, toggle, or other mechanism or actuator that senses when the lid has moved from the closed position to the open position, and vice versa. The sensor 220 may comprise an active or passive (e.g., digital or analog) sensing mechanism.

The sound emitter 225 may be utilized to provide an audible sound or a light etc. For example, upon the elapse of a predetermined period of time (as determined by the timer 215 and/or the controller 210, the sound emitter 225 may be activated to provide an audible sound such as an alarm, a ding, a word/phrase, or any other audible sound. The sound emitter 225 may be activated from a signal received from either the timer 215 and/or the controller 210. In some instances the sound emitter 225 may comprise a speaker.

In some instances, closing the lid causes the sound emitter 225 to cease providing the audible sound. In other instances, sequenced movements of the lid causes the sound emitter 225 to cease providing the audible sound. For example, during provision of the audible sound, sequential opening and closing of the lid may cause the sound emitter 225 to cease providing the audible sound.

The display 235 may include the display 148 as shown in FIG. 4. The display may receive timer information or signals from either of the timer 215 and/or the controller 210. The display 148 may show an icon that references the current power level of the energy source 205.

The transmitter 230 may comprise any transmitting device capable of sending a digital and/or analogue signal over a wired or wireless connection. Exemplary transmitters may include passive and active radio frequency identification (“RFID”) transmitters, a Bluetooth transceiver, and so forth. The transmitter 230 may be utilized to send timer signals to monitoring devices such as a base station, a personal computer, a mobile device, a watch, or any other computing device capable of communicatively coupling with the transmitter 230.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A container, comprising:
a body comprising a cavity for receiving a pill, the body having an opening for dispensing the pill;
a timer; and
a lid operatively connected to the body, the lid being selectively movable between a closed position to retain the pill within the body and an open position for dispensing the pill from the body, wherein selectively moving the lid from the closed position to the open position activates a timer.

2. The container according to claim 1, wherein the timer incrementally counts up once the lid has been selectively moved from the open position to the closed position.

3. The container according to claim 1, wherein the timer incrementally counts down for a period of time once the lid has been selectively moved from the open position to the closed position.

4. The container according to claim 1, wherein the timer is associated with a display that provides a time reference provided by the timer.

5. The container according to claim 1, wherein the lid houses at least a portion of the timer.

6. The container according to claim 1, further comprising a sound damping material lining at least a portion of a sidewall of the body that defines the cavity.

7. The container according to claim 1, further comprising a hatch associated with the body, the hatch providing access to the cavity.

8. The container according to claim 7, wherein the hatch comprises an outer surface that is substantially flush with an outer surface of the body when the hatch is in a closed configuration.

9. The container according to claim 1, further comprising an actuator mounted on the body, the actuator causing selective movement of the lid from the closed position to the open position when the actuator is engaged.

10. The container according to claim 9, wherein the actuator comprises a button associated with the body and a locking member associated with the body, the locking member adapted to engage with the lid when the lid is in the closed position to prevent the lid from moving into the open position until the button is depressed.

11. The container according to claim 10, wherein when the locking member is disengaged from the lid the timer is activated.

12. The container according to claim 10, wherein an outer surface of the button is substantially flush with an outer surface of the body.

13. The container according to claim 1, wherein the body further comprises a window that provides a view into the cavity.

14. The container according to claim 13, wherein the window is at least partially opaque.

15. The container according to claim 1, wherein the lid is in hinged connection with the body.

16. The container according to claim 1, further comprising a transmitter that outputs a timer signal that comprises an indication that the timer has been activated.

17. The container according to claim 1, further comprising a sound emitter that is activated by the timer upon elapse of a predetermined period of time, the sound emitter providing an audible sound when activated.

18. The container according to claim 17, wherein closing the lid causes the sound emitter to cease providing the audible sound.
